(19) United States
(12) Patent Application Publication
(10) Pub. No.: US 2013/0331149 A1
(43) Pub. Date: Dec. 12, 2013

(54) TACTILE INDICATION OF TRANSMISSION QUALITY IMPAIRMENTS

(71) Applicant: Paul Roller Michaelis, Louisville, CO (US)

(72) Inventor: Paul Roller Michaelis, Louisville, CO (US)

(73) Assignee: AVAYA INC., Basking Ridge, NJ (US)

(21) Appl. No.: 13/490,702

(22) Filed: Jun. 7, 2012

(51) Int. Cl. G08B 6/00; H04M 1/00

(52) U.S. Cl. 455/566; 455/550.1

(57) ABSTRACT

Systems and methods for providing a tactile alert or indication of a condition comprising a transmission quality impairment affecting a communication device are provided. More particularly, in response to detecting a transmission quality impairment, a tactile alert can be provided to the user of the communication device. The tactile alert can be varied in a recognizable way to indicate the type and/or degree of impairment. The generation of a tactile alert allows the user to be apprised of the condition, which may prevent the provision of speech or other input by the user from being clearly received by other communication endpoints, to be provided with certainty. Moreover, the condition can be communicated in compliance with communication device accessibility requirements.

### FIELD

Systems and methods for providing a tactile indication of transmission quality impairments are provided.

### BACKGROUND

Many factors that can degrade the quality of telephone transmissions are detectable automatically by telephones or other communication devices. For example, weak radio signals in cellular or Wi-Fi devices can be detected. Communication devices can also detect harmful acoustic factors that may be unrecognized by the user, such as excessively loud speaking, echo, and background sounds. Still other factors that can affect transmission quality are related to communication networks. Such factors include jitter, packet loss, and other network quality of service type issues. A user who is unaware of transmission problems may assume inappropriately that he or she is being heard clearly by other parties to a communication.

Although communication devices are able to detect the presence of factors that can degrade the quality of transmitted voice signals, cellular telephones in particular do not notify users in a satisfactory manner when these impairments are detected. As an example, the most common approach for providing transmission quality feedback relies on visual indicators, such as signal strength bars that graphically depict the strength of a radio signal. Audible alerts, such as “low battery warning” chirps, are common in cordless and wireless telephones. As another example, the side tone provided to a user can be purposefully degraded, to provide an indication that transmission quality is compromised.

It is not reasonable to expect the user of a portable phone to see visual indicators while speaking into the phone. Even if this were not an issue, the provision of information solely by visual means may not comply with laws related to the accessibility of telephony devices to individuals with disabilities. In particular, this is because people with visual impairments cannot access the information.

Audio mechanisms that provide signal quality feedback by artificially degrading or interrupting the received signal have the disadvantage of making it even harder to communicate. Mechanisms that provide such feedback by artificially degrading the side tone can overcome this deficiency, but it is not clear that users of cell phones are adequately sensitive to side tones while they are speaking. In addition, the provision of information solely by auditory means can also violate applicable accessibility laws, because people with hearing impairments, notably those who rely on TTY or other real time text based communication, cannot access the information.

### SUMMARY

Systems and methods for providing a tactile indication of transmission quality impairments are provided. More particularly, a communication device is provided that includes a tactile user output device or tactile alert generator, such as a vibrator. In response to the detection of an impaired transmission quality condition, the tactile output device is operated to provide the user with a tactile indication of the impaired transmission quality condition. The tactile indication can be varied in a recognizable way depending on the type of impairment and/or the degree of impairment, thereby allowing the user to make a sensible decision about remediation steps.

Systems in accordance with the present disclosure include a communication device. The communication device incorporates or is associated with a tactile output device. As an example, but without limitation, the tactile output device may comprise a vibrator. The system can also include memory containing application instructions or programming, and a processor for executing the application. The application operates to cause the tactile output device to generate a tactile alert signal in response to determining or receiving an indication that transmission conditions are impaired. In response to the indication of the impaired transmission condition, by the tactile alert alone or in combination with information provided through alternate means, the user can take remedial action. For example, the user can move to a location at which signal strength is greater or background noise is lower, can speak at a lower volume, or can choose to discontinue the call until conditions have improved.

Methods in accordance with embodiments of the present disclosure include detecting a condition related to a communication channel that is available to or that is being used by a communication device. The method can further include determining whether the user of the communication device should be alerted to the detected condition. For example, a determination may be made that the user of the communication device should be alerted to the detected condition when the detected condition affecting a communication channel comprises a transmission quality impairment. In response to a determination that an alert should be provided, the method includes generating a tactile alert. In accordance with further embodiments, the tactile alert may only be generated while the communication channel is being used by the communication device. In accordance with still other embodiments, the generation of a tactile alert can be performed when it is determined that a display associated with the communication device is not in view of the user. In accordance with still other embodiments, the method includes providing information identifying the detected condition to the user. This information can be in the form of variations in the tactile alert signal.

Additional features and advantages of embodiments of the present disclosure will become more readily apparent from the following discussion, particularly when taken together with the accompanying drawings.

### BRIEF DESCRIPTION OF THE DRAWINGS

FIG. 1 illustrates components of a communication system in accordance with embodiments of the present disclosure;

FIG. 2 depicts components of a communication device in accordance with embodiments of the present disclosure; and

FIG. 3 is a flowchart depicting aspects of a method in accordance with embodiments of the present disclosure.

### DETAILED DESCRIPTION

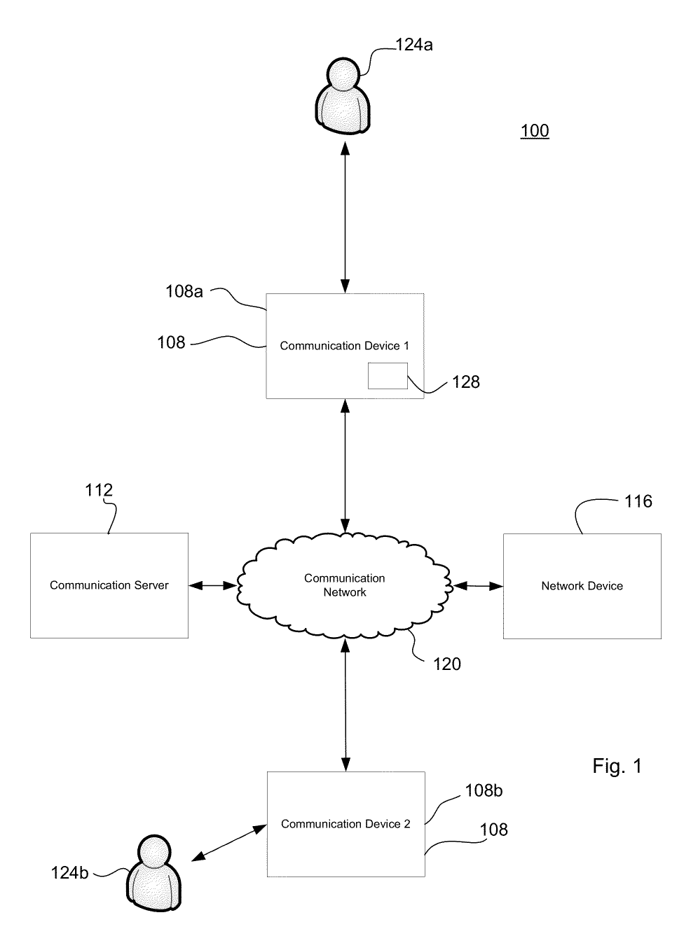

FIG. 1 is an illustration of a communication system 100 in accordance with embodiments of the present disclosure. The communication system 100 generally includes one or more communication devices 108, a communication server 112, and/or a network device 116. The various devices 108, 116 and servers 112 may be interconnected to one another by one or more communication networks 120. In general, each communication device 108 is associated with a user 124.

A communication device 108 may comprise a device that is capable of receiving input from and providing output to a user 124. Moreover, a communication device 108 may have the capability of participating as an endpoint in communication sessions utilizing or in association with transmissions comprising communication channels that are established at least in part over the communication network 120. Accordingly, examples of a communication device 108 include, but are not limited to, a cellular telephone, a satellite telephone, a wireless telephone, a smart phone, or other telephony device or general purpose computer that provides telephony functions. Moreover, in accordance with embodiments of the present disclosure, at least one communication device 108 within the system 100 includes a tactile output device 128 and instructions or programming for operating the tactile output device 128, as described herein. In the depiction of the system 100 shown in FIG. 1, two communication devices 108a and 108b, each associated with a respective user 124a and 124b are shown. However, it should be appreciated that any number of communication devices 108 can be included in a system 100. For example, a single communication device 108 may be provided, for example where communications are between the communication device 108 and a communication server 112. As a further example, more than two communication devices 108 can be included in a multiple party conference call scenario.

A communication server 112 may comprise a feature or application server that supports operation of one or more communication devices 108, alone or in connection with the communication network 120. Accordingly, examples of a communication server 112 include a private branch exchange (PBX), a sequenced application server, a contact center server, or other device providing telephony functions to one or more communication devices 108.

A network device 116 may comprise a node that is included in or associated with the communication network 120. Accordingly, examples of a network device 116 include gateways, switches, access points, bridges, routers, or the like.

The communication network 120 may comprise a packet data network, a cellular telephony network, a circuit based network, or a variety of networks of different types, either alone or in combination. Moreover, some or all of the communication network 120 can include a local area network, an enterprise network, such as a private intranet, or a public network, such as the Internet or the public switched telephony network, or other publicly or privately accessible local area network or wide area network.

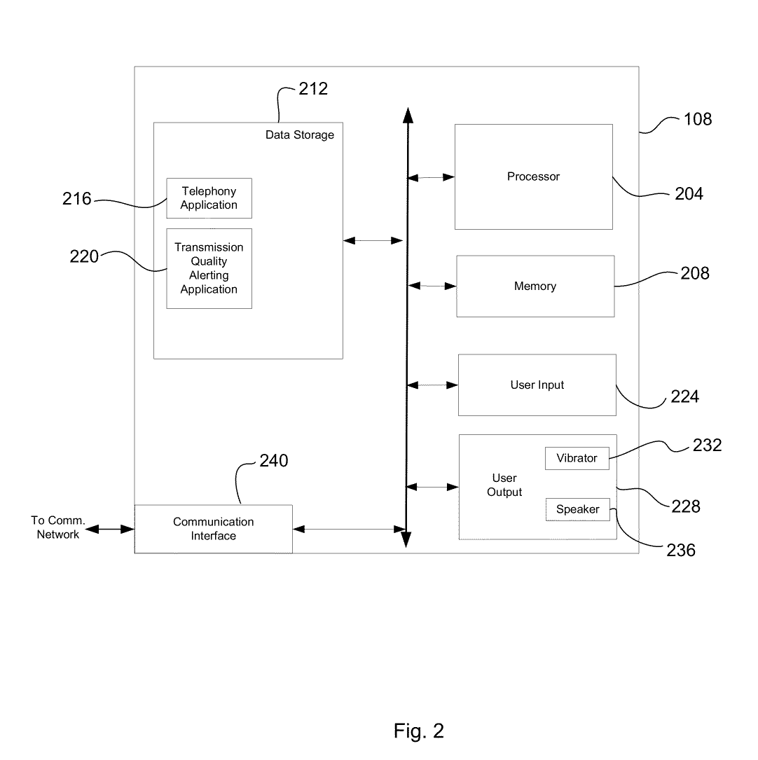

FIG. 2 illustrates components of a communication device 108 in accordance with embodiments of the present disclosure. In general, the communication device 108 can support communications between a user 124 of the communication device 108 and a user of another communication device 108, a communication server 112, or a network device 116. In an exemplary embodiment, a communication device 108 comprises a cellular telephone.

The communication device 108 generally includes a processor 204 capable of executing program instructions. The processor 204 may comprise any general purpose programmable processor or controller for executing application programming. Alternatively, the processor 204 may comprise a specially configured application specific integrated circuit (ASIC). The processor 204 generally operates to run programming code implementing various functions performed by the communication device 108. These functions can include the provision of a tactile alert signal to a user 124 as described herein.

The communication device 108 additionally includes memory 208. The memory 208 can be used in connection with the execution of programming by the processor 204, and for the temporary or long term storage of data and/or program instructions. As examples, the memory 208 may comprise a computer readable medium such as RAM, SDRAM, or other solid state memory. Alternatively or in addition, data storage 212 may be provided. In accordance with embodiments of the present disclosure, the data storage 212 may contain programming code or instructions implementing various applications or functions executed or performed by the communication device 108. Like the memory 208, the data storage 212 may comprise a computer readable memory, such as RAM, SDRAM, or other solid state memory. Alternatively or in addition, the data storage 212 may comprise another type of tangible computer readable medium, such as a hard disk drive or other random access memory. As an example, the data storage 212 can include a telephony application 216 and a transmission quality alerting application 220, as described herein.

In addition, the communication device 108 includes a user input device 240. As an example, a user input device 240 may comprise a keypad, a keyboard, touch screen, microphone, and the like. In general, a user input device 240 allows a user 124 to provide control inputs and/or data to the associated communication device 108. For example, a user input device or devices 240 can be operated by a user 124 to dial a number, such as a telephone number.

The communication device 244 also includes one or more output devices 244. In particular, embodiments of the present disclosure include a communication device 108 with an output device 228 comprising a vibrator 232 and a speaker 236. Other examples of user output devices 228 that can be provided as part of a communication device 108 include a display, indicator lamps, and the like.

A communication interface 240 is also included as part of the communication device 108. The communication interface 240 can further comprise a plurality of different communication interfaces. Examples of a communication interface or interfaces 240 include a cellular telephony, Wi-Fi, satellite telephony, proprietary wireless network, circuit switched network interface, wired Ethernet interface, or the like. Accordingly, a communication interface 240 is not necessarily restricted to any particular network type or protocol. In general, the communication interface 240 operates to interconnect the communication device 108 to a communication network 120. Moreover, where a communication device 108 includes a plurality of communication interfaces 240, the particular communication interface 240 used with respect to or available for communications can be determined by the particular communication network 120 available at that time, and/or by a selection by the user 124.

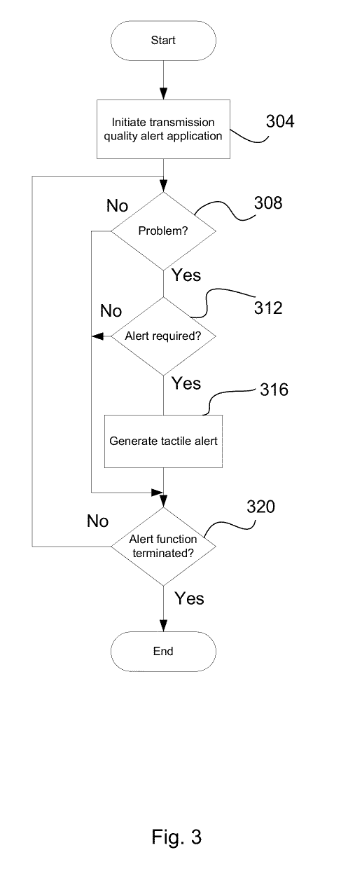

FIG. 3 illustrates aspects of the operation of a system 100 in accordance with embodiments of the present disclosure. More particularly, this illustrated process can be performed in connection with the execution of the transmission quality alerting application 220 by the processor 204 of a communication device 108. Initially, at step 304, the transmission quality alerting application 220 is initiated. In accordance with embodiments of the present disclosure, the transmission quality alerting application 220 can be initiated anytime the communication device 108 is powered on, and/or is otherwise operational for communication operations. In accordance with further embodiments, the transmission quality alerting application 220 can be selected through communication device 108 settings selected by the user 124 and/or an administrator. Alternatively or in addition, the alerting application 220 can be configured as to the type of transmission or communication channel impairment and/or the severity of such an impairment that will result in the generation of a tactile alert signal. In accordance with still other embodiments, the transmission quality alerting application 220 can be initiated when the communication device 108 is connected to a communication network 120, either in a standby or in an active mode.

Once the transmission quality alerting application 220 has been initiated, a determination can be made as to whether a condition, and in particular a transmission quality impairment affecting the communication device 108, exists or can be identified (step 308). Examples of impairments or problems include any problem related to a communication channel that might affect the quality of service experienced by any endpoint, including but not limited to the communication device 108, that is a party to an active communication session or a potential communication session. Accordingly, examples of such transmission quality impairments or conditions include problems related to communication channel signal strength, communication channel noise, including but not limited to noise in the communication network 120 or an associated link, background noise in the ambient environment, a user 124 that is speaking too loudly, communication network 120 performance issues, such as excessive jitter or packet loss, or any other detectable condition that is or that might affect the quality of a communication session including the communication device 108. The existence of such a problem can be communicated to the transmission quality alerting application 220 by the telephony application 216 and/or by nodes connected to the communication device 108 by the network 120, including but not limited to other communication devices 108, a communication server 112 or network device 116.

If a transmission impairment or problem condition related to or affecting a communication channel available to or being used by the communication device 108 is detected, a determination can next be made as to whether the user 124 of the communication device 108 should be alerted to that condition (step 312). For example, if the detected condition is determined to be of a magnitude or nature such that speech or other information by the user 124 through the communication device 108 might not be clearly received by another endpoint to a communication session, such as a second communication endpoint 108, or a communication server 112, a determination can be made that the user 124 should be alerted to the condition. In particular, by alerting the user 124 to the condition, the user can take remedial action. For example, the user 124 can address the condition comprising the transmission impairment itself, for example by moving to an area with better signal strength, moving to an area with less background noise, or talking more quietly. As yet another example, the user 124 may choose to defer placing a call until conditions have improved, or can terminate an in process call with the intent of continuing that call at a later time, after conditions have improved.

If a determination is made that an alert is required or should be provided, a tactile alert is generated (step 316). The tactile alert can be generated for as long as the impaired transmission quality condition exists. Alternatively, the tactile alert can be discontinued after some period of time. As used herein, a tactile alert is an alert that can be apprehended by a user 124 through the sense of touch. Accordingly, an example of generating a tactile alert includes operating the vibrator 232 included in the communication device 108 to alert the user 124 to the condition affecting transmission quality.

The particular format of the tactile alert can be varied, depending on the identity, nature, severity, and/or other characteristic of the detected transmission impairment or communication channel condition. For purposes of illustration, but without limitation, the presence and severity of radio signal impairments could be indicated by the lack of vibrational tapping when the signal strength is good, a periodic single tap from the vibrator 232 when the signal strength is down by one bar, a periodic double tap when the signal strength is down by two bars, and a periodic triple tap when the signal strength is down by three bars. As another example, a user 124 speaking so loudly that the transmitted voice signal is distorted could be notified by vibration having a strength that varies with the loudness of their speech. As yet another example, the presence of acoustic echo in the communication channel could be indicated by a strong vibration followed by a medium vibration followed by a weak vibration.

In accordance with further embodiments of the present disclosure, after or in connection with the generation of a tactile alert, additional information can be provided to the user 124 through other means. For example, the generation of a tactile alert can be accompanied by the presentation of information through an output device 228 comprising a display, to present information regarding the nature and/or severity of the condition that caused the alert to be generated. In accordance with still other embodiments, the generation of a tactile alert can be performed when it is determined that a display is not accessible to a user 124. For instance, a user who is visually impaired can enable tactile alerts in all operating situations. As another example, a tactile alert can be generated when it is determined that the display included as an output device 228 of the communication device 108 is not currently in view of the user 124. For instance, when the speaker 236 of the communication device 108 is being used in a mode in which it is held to the ear of the user 124, and therefore the display is not in view of that user 124, the tactile alert generation function can be used. Conversely, when the speaker 236 is used in a speaker phone mode, embodiments of the present disclosure can provide an alert of the condition through non-tactile means. As yet another example, when a communication device 108 is operatively connected to an associated input/output system, for example through a Bluetooth connection to a wireless headset or an automobile audio system, the alert can be made through an audible mechanism, rather than through a tactile or visual mechanism. Accordingly, the current operating mode of the communication device 108 can be provided as an input to the transmission quality alerting application 220, and can affect the determination as to whether to generate a tactile alert.

At step 320, a determination can be made as to whether the alert function has been terminated. For example, if the communication device 108 has powered down, or the alert function has been turned off through a selection made by the user 124, the process can end. Alternatively, the process can return to step 308, and the condition of transmission quality parameters can continue to be monitored.

The provision of a tactile alert is a significant advance over providing information regarding conditions affecting transmission quality through other means. Significantly, the tactile alert overcomes deficiencies in other alert mechanisms in that accessibility requirements associated with communication devices can now be met. Moreover, although indications of conditions have been available through various means, until the present disclosure, a technique for providing an alert through means that are compliant with the accessibility laws, including as an example section 508 of the Rehabilitation Act, which governs aspects of the operation of electronic communication devices, has not been available.

In an exemplary scenario, the communication device 108 comprises a cellular or other wireless telephone. The tactile alert generated in response to detecting a condition affecting transmission quality and in response to determining that an alert should be provided to the user 124 is provided by a vibrator 232 included in the communication device 108. The vibrator 232 can be the same mechanism that is used to provide a “silent ring” function. Moreover, the pattern of vibration output by the vibrator 232 can be differentiated from the ring function. The pattern can be different for different conditions and/or condition severity. Accordingly, information regarding the nature of a detected event can be provided through the vibrator 232 as part of the tactile alert.

The foregoing discussion of the invention has been presented for purposes of illustration and description. Further, the description is not intended to limit the invention to the form disclosed herein. Consequently, variations and modifications commensurate with the above teachings, within the skill or knowledge of the relevant art, are within the scope of the present invention. The embodiments described hereinabove are further intended to explain the best mode presently known of practicing the invention and to enable others skilled in the art to utilize the invention in such or in other embodiments and with various modifications required by the particular application or use of the invention. It is intended that the appended claims be construed to include alternative embodiments to the extent permitted by the prior art.

What is claimed is:

1. A method for providing an alert to a user of a communication device, comprising:
detecting a transmission impaired condition related to a communication device;
determining that user of the communication device should be alerted to the detected condition;
generating a tactile alert.

2. The method of claim 1, wherein the tactile alert is a vibration.

3. The method of claim 1, wherein the detected condition is a transmission quality impairment.

4. The method of claim 3, wherein the transmission impairment is identified as at least one of: a weak radio signal; excessively loud input by a user of the communication device; echo; packet loss; jitter; quality of service; and background noise.

5. The method of claim 1, further comprising:
after generating the tactile alert, receiving input from a user of the communication device;
in response to the received input, providing information identifying the detected condition.

6. The method of claim 5, wherein the information identifying the detected condition is provided as at least one of displayed text and speech.

7. The method of claim 6, wherein the information identifying the detected condition is provided as speech.

8. The method of claim 5, wherein the received input includes the user moving the phone from the ear of the user.

9. The method of claim 1, wherein the communication device includes a display, the method further comprising:
determining that the display is not in view of a user of the communication device, wherein the tactile alert is generated after determining that the display is not in view of the user, wherein the communication device is a telephone, and wherein determining that the display is not in view of the user includes determining that a speaker integrated with the telephone is in use in a non-speaker phone mode.

10. The method of claim 1, wherein the communication channel is being used by the communication device.

11. The method of claim 1, wherein the tactile alert is different for different conditions related to the communication channel.

12. A communication system, comprising:
a communication device, including:
an audible signal input device;
an audible signal output device;
a tactile output device;
a communication interface, wherein in response to a signal indicating a transmission quality impairment of a communication including the communication device, a tactile alert is generated by the tactile output device.

13. The system of claim 12, wherein the communication device additionally includes:
a processor;
memory;
application instructions stored in the memory and executed by the processor, wherein the application instructions cause the tactile output device to generate the alert signal in response to the signal indicating a transmission quality impairment.

14. The system of claim 13, wherein the signal indicating a transmission quality impairment is at least one of provided to the communication device by a communication network component connected to the communication device by a communication network, or generated by the application instructions.

15. The system of claim 12, wherein the tactile alert generator is a vibrator.

16. A tangible computer readable medium having stored thereon computer executable instructions, the computer executable instructions causing a processor to execute a method for providing a tactile alert to a user of a communication device, the computer readable instructions comprising:
instructions to determine a condition of a communication channel;
instructions to generate a tactile alert in response to a determination that the condition of the communication channel is compromised.

17. The tangible computer readable medium of claim 16, wherein the condition of the communication channel is determined while the communication channel is in use by a communication device.

18. The tangible computer readable medium of claim 17, wherein the tangible computer readable medium is provided as part of the communication device.

19. The tangible computer readable medium of claim 18, wherein the instructions further comprise instructions to identify the condition, wherein the tactile alert is different for different conditions.

20. The tangible computer readable medium of claim 18, wherein the communication device is a telephone.
